(19) United States
(12) Patent Application Publication
(10) Pub. No.: US 2024/0185531 A1
(43) Pub. Date: Jun. 6, 2024

(54) MANUFACTURING CUSTOMIZATION BASED ON A REFERENCE OBJECT

(71) Applicant: INTERNATIONAL BUSINESS MACHINES CORPORATION, ARMONK, NY (US)

(72) Inventors: Jeremy R. Fox, Georgetown, TX (US); Michael Boone, Lutz, FL (US); Tushar Agrawal, West Fargo, ND (US); Sarbajit K. Rakshit, Kolkata (IN)

(21) Appl. No.: 18/061,186

(22) Filed: Dec. 2, 2022

(51) Int. Cl. G06T 19/00; B29C 64/393; B33Y 50/02

(52) U.S. Cl. CPC G06T 19/00; B29C 64/393; B33Y 50/02

(57) ABSTRACT

A 3D model modification system may receive a 3D model and information on a physical object. The 3D model modification system may modify the 3D model to interface with the physical object and manufacture the 3D model into a 3D physical part.

### BACKGROUND

Aspects of the present disclosure relate to manufacturing customization based on a reference object.

Rapid prototyping is a group of techniques used to quickly fabricate a scale model of a physical part or assembly using three-dimensional computer aided design data. Construction of the part or assembly is usually done using three-dimensional (3D) printing or “additive layer manufacturing” technology.

### BRIEF SUMMARY

The present disclosure provides a method, computer program product, and system of manufacturing customization based on a reference object. In some embodiments, the method includes receiving a three-dimensional (3D) model, receiving information on a physical object, identifying an abutment between the 3D model and the physical object from the information, identifying one or more constraints on the 3D model using the information, modifying the 3D model to interface with the physical object at the abutment and subject to the constraints, and manufacturing the 3D model into a 3D physical part.

Some embodiments of the present disclosure can also be illustrated by a computer program product comprising a computer readable storage medium having program instructions embodied therewith, the program instructions executable by a processor to cause the processors to perform a method, the method comprising receiving a three-dimensional (3D) model, receiving information on a physical object, identifying an abutment between the 3D model and the physical object from the information, identifying one or more constraints on the 3D model using the information, modifying the 3D model to interface with the physical object at the abutment and subject to the constraints, and manufacturing the 3D model into a 3D physical part.

Some embodiments of the present disclosure can also be illustrated by a system comprising a processor and a memory in communication with the processor, the memory containing program instructions that, when executed by the processor, are configured to cause the processor to perform a method, the method comprising receiving a three-dimensional (3D) model, receiving information on a physical object, identifying an abutment between the 3D model and the physical object from the information, identifying one or more constraints on the 3D model using the information, modifying the 3D model to interface with the physical object at the abutment and subject to the constraints, and manufacturing the 3D model into a 3D physical part.

### BRIEF DESCRIPTION OF THE DRAWINGS

FIG. 1 depicts a computer system according to various embodiments of the present invention.

FIG. 2 illustrates an example method of manufacturing customization based on a reference object, according to various embodiments of the present invention.

FIG. 3 illustrates one representation of a set of neural networks in a larger aggregate neural network that may prepare input data for a probability-generator neural network, in accordance with embodiments.

FIG. 4 depicts an example neural network that may be specialized to process a vector or set of vectors associated with a word type (e.g., entity vectors), in accordance with embodiments.

FIG. 5 illustrates an example probability-generator neural network with multiple pattern recognition pathways and multiple sets of inputs, in accordance with embodiments.

FIG. 6 illustrates a representation of a system that utilizes multiple probability-generation neural networks and structured data to generate a composite projection, in accordance with embodiments.

### DETAILED DESCRIPTION

Aspects of the present disclosure relate to manufacturing customization based on a reference object. While the present disclosure is not necessarily limited to such applications, various aspects of the disclosure may be appreciated through a discussion of various examples using this context.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as three-dimensional (3D) model modification system represented by block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

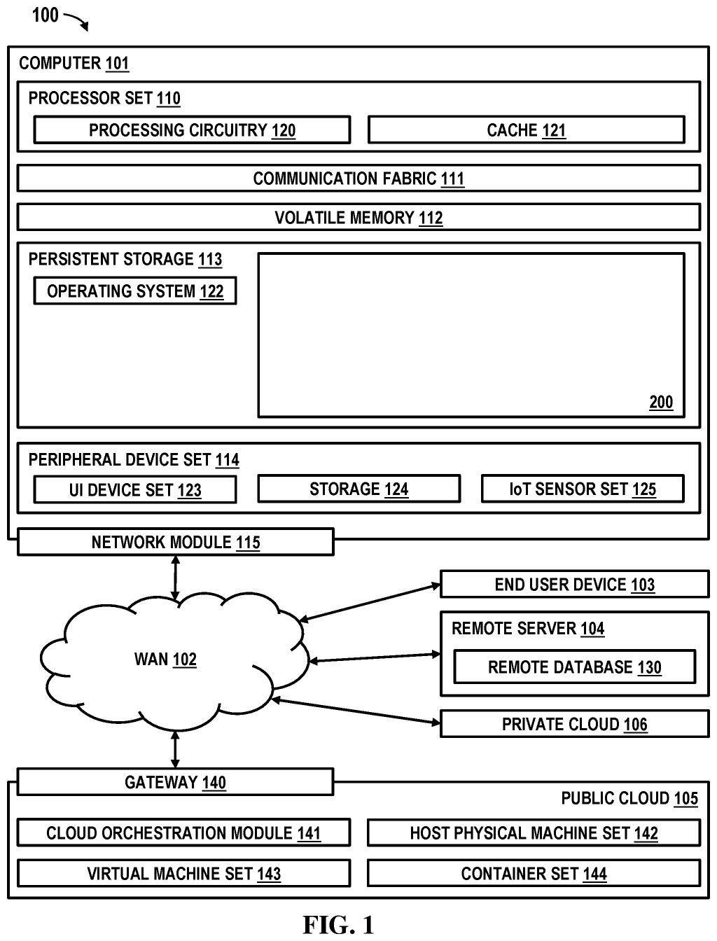

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some instances, images of physical objects may be used to obtain dimensional information of the objects. In some instances, dimensional information may be a 3D image, distances between points, dimensions of an object, or a shape of an object.

Rapid prototyping may be used to build 3D physical parts, which, as used herein, includes physical items that have designed features that are configured and manufactured to change in size and/or character across three dimensions. Rapid prototyping is the fabrication of a physical part or assembly using 3D computer-aided design (CAD), often where the fabrication is of a scale model of an eventual/final version of the respective part. As suggested by the name, rapid prototyping may be faster than conventional methods of fabricating the physical part or assembly, which might include creating two-dimensional blueprints which are used to manually program high-volume manufacturing equipment. The creation of the part or assembly may be formed using additive manufacturing, which is more commonly known as 3D printing.

However, rapid prototyping as used herein might also include the use of other technologies such as subtractive fabrication, compressive manufacturing, high-speed machining, casting, molding, extruding, or the like. For example, subtractive fabrication starts with a block of material that is carved to produce the desired shape using milling, grinding or turning. Likewise, compressive manufacturing uses semi-solid or liquid material and shapes this material into the desired shape before the material is solidified, such as with casting, compressive sintering, or molding. Though printing a part is primarily discussed herein for the sake of discussion, it is to be understood that any other rapid-prototyping technique may be used in the examples and discussion below unless specified otherwise.

While printing any 3D part, a user might want to customize the digital 3D model in reference to a physical object. For example, the user may desire to make sure a printed part fits on a side table. Therefore, in some embodiments, a method for adjusting 3D models based on physical objects is proposed.

In rapid prototyping, a finished part that closely matches the proposed design may be called a high fidelity prototype. Comparatively, a finished part with a marked difference in relation to the proposed design may be called a low fidelity prototype.

While printing any 3D part, a user might want to customize the digital 3D model upon which the 3D part is based, and during customization, the user might refer to a physical object and may desire to modify the 3D model so that the eventual printed 3D physical part may interface with the physical object. However, this modification may be done in such a way that it primarily or exclusively relates to enabling the desired interfacing with the desired object, such that the modification does not diminish functionality or alter dimensions that do not relate to that desired interfacing. That is, the 3D model may be modified with respect to some aspects (e.g., such that one identified surface is changed to be flat rather than rounded so that the printed part will be steady when that identified surface is placed on a table), but constrained with respect to other aspects (e.g., such that other surfaces that are adjacent the identified surface may still be subsequently assembled with other prototyped parts into a larger prototype object). In some instances, the printed part “interfacing” with the physical object may refer to a physical interaction between the printed part and the physical object. For example, if fabricating an accessory part for a toy car, the printed part must be sized and shaped to interface with the mockup car or it will not fit.

In many applications, it is relatively easy for users to find “generic” 3D models for a part that the user is wishing to have manufactured into a 3D physical part. For example, a user may find a vendor online that provides free 3D models that this vendor may print and deliver it to the user. This might include a situation where a user owns an object of a model sports utility vehicle (SUV) and may identify a 3D model relating to a part such as a model roof rack. However, in many instances these “generic” or “default” 3D models may be suboptimal at interfacing with an object that the user has in mind. For example, the roof rack 3D model may not be configured to clip into grooves of the SUV model object owned by the user.

Accordingly, a user may provide information of the object so that the 3D model may be modified. This may include the user identify that physical object (e.g., providing sufficient information that the relevant contours of the abutment between the physical object and the eventual printed object are known), or the user providing a digital representation of a physical object. In some embodiments, a 3D model modification system may analyze a physical object (e.g., by making a 3D model of the object or measuring a dimension of the object) to determine one or more physical characteristics (e.g., a dimension, an angle between surfaces, etc.). In some embodiments, the 3D model modification system may receive input from a user (e.g., through a terminal or voice commands) to determine how the physical object relates to the 3D model. For example, where the physical object is a mockup car and the desired physical part to be manufactured is a driver (to fit inside of a mockup car), the 3D model modification system may be configured to receive and understand natural language instructions stating as much.

In some embodiments, the 3D model modification system may use the physical characteristics and the input to modify the 3D model. In some embodiments, the modification may include changing the shape or dimension of the 3D model and/or changing a material to be used for a rapid prototyping of the 3D model. In some embodiments, the system may also modify the rapid prototyping of the 3D model to change the weight distribution or center of gravity. For example, if a dimensional modification has the potential to make the prototyped part unstable, the 3D model modification system may make one or more portions of the prototyped part hollow, thereby changing the center of gravity of the printed part.

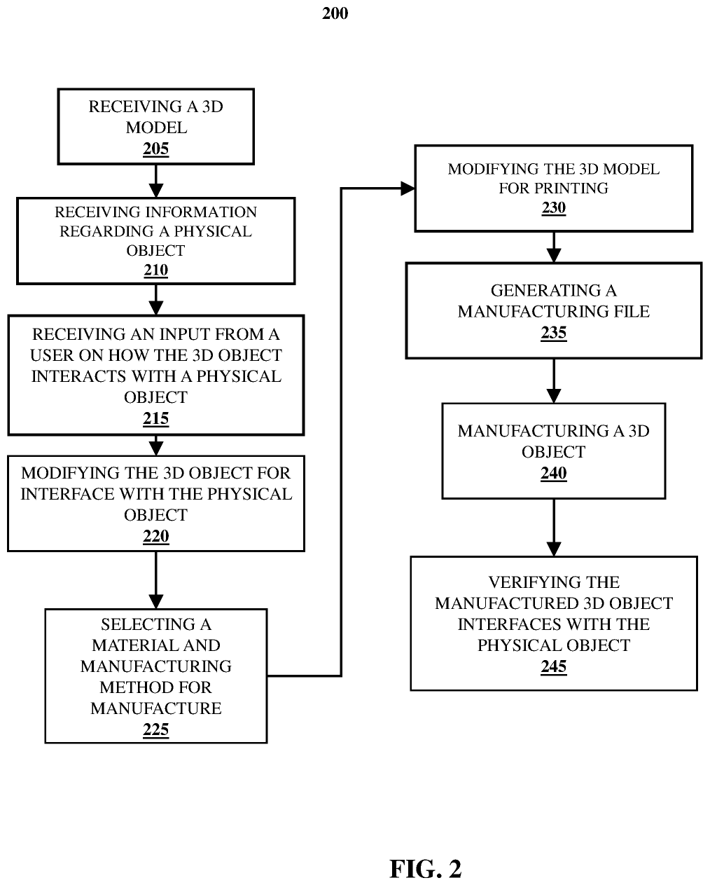

FIG. 2 depicts an example method 200 for manufacturing customization based on a reference object. Operations of method 200 may be enacted by one or more computer systems such as the 3D model modification system described in block 150 FIG. 1 above.

Method 200 begins with operation 205 of receiving a 3D model (e.g., a CAD model) for manufacture (e.g., rapid prototyping such as 3D printing). For example, a user may select or provide a 3D model for printing in an online portal.

In operation 210, the 3D model modification system may receive information regarding a physical object. In some embodiments, the information may be physical characteristics of the physical object measured using an associated 3D scanning system. For example, the information may be a physical characteristic of the physical object including a dimension, a shape, a weight, a material, a center of gravity, a density, and/or another physical characteristic.

In operation 215, the 3D model modification system may receive an input from a user on how the 3D part, when manufactured, is to interface with the physical object at a specific identified abutment. For example, the 3D model may depict a vase to be set on an object of table, or the 3D model may be a steering wheel piece to fit inside an object of a mockup car. In some embodiments, interface may mean match, fit, accommodate, mate, join with, and/or another way for two physical objects to interact with each other.

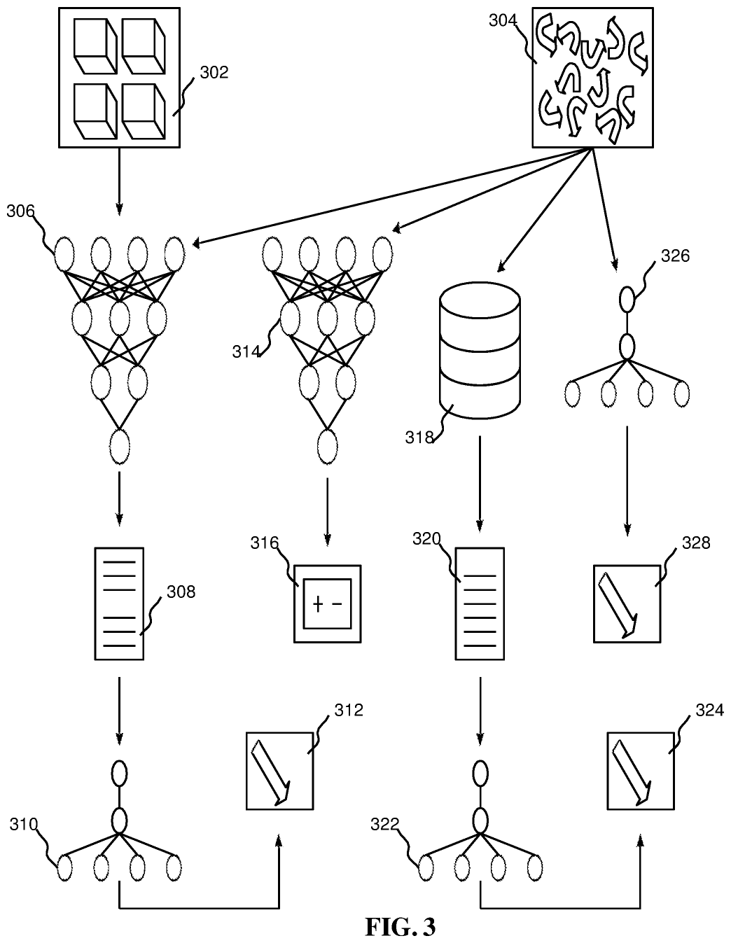

Using the 3D model, the information regarding a physical object, and the input from the user, the 3D model modification system may modify the 3D model to interface with the physical object in operation 220. For example, if the 3D model has a driver piece that is too big to fit inside the mockup car, the 3D model modification system may reduce the size of the 3D model to fit in the mockup car. In another example, if the 3D model is a 1′×1′×1′ box and it is to fit on a table top that is 0.5′×1′, the 3D model modification system may change one dimension of the box from 1′ to 0.5′ so that the box fits on top of the table without hanging over the edge of the table top. In some embodiments, the modification may be done with neural networking and machine learning to configure the 3D model, as described in FIGS. 3-6 below.

The 3D model modification system may select a material and manufacturing method for manufacture of the 3D model in operation 225. In some embodiments, the information may include physical requirements for the manufactured 3D part such as tensile strength, compressive strength, elasticity, surface roughness, layer adhesion, weight, conductivity, etc. Various manufacturing techniques and materials may produce parts with different finished properties. For example, a part used for a knee replacement may need to be made out of titanium, and thus, a 3D printing process that sinters metals may be used.

In operation 230 the 3D model modification system may modify the 3D model for select printing properties such as weight, position of the center of gravity, and density according to the use of the manufactured 3D part. The 3D model may be customized to modify the configuration of the printed 3D part. For example, a 3D part may be customized so the center of gravity of the part is at the base of the part to give the part more stability. Similarly, the 3D part may be customized to be hollow thereby reducing the weight of the printed part and cost of printing. In some embodiments, the modification may be done with neural networking and machine learning to configure the 3D model, as described in FIGS. 3-6 below. For example, machine learning may be used to identify how a final printed part compares to the 3D model and fits a physical object.

A manufacturing file may be generated from the 3D model in operation 235. Some 3D printing technologies require a specific manufacturing file (e.g., a slice file for 3D printing), thus the modified 3D model may be converted into the printing file. In some instances, a printing file may be a file used in a manufacturing process and may be called something other than a printing file. In some embodiments, neural networking and machine learning may be used to create the manufacturing file. For example, a set of 3D models may be compared to printed parts to determine how the parts interface with physical objects in order to adjust the manufacturing files accordingly.

In operation 240 the printing file may be used to manufacture the 3D part. For example, the printing file may be used in a rapid prototyping system that is able to manufacture physical parts from printing files.

The 3D model modification system may verify the manufactured 3D part interfaces with the physical object correctly in operation 245. For example, a printed part may be measured to verify that the part has been printed to the proper specifications. In some embodiments, the verifying may include taking measurements of the printed part and the physical object or abutting the objects to see if they fit.

Artificial neural networks (ANNs) can be computing systems modeled after the biological neural networks found in animal brains. Such systems learn (i.e., progressively improve performance) to do tasks by considering examples, generally without task-specific programming. For example, in image recognition, ANNs might learn to identify 3D model that will interface properly with real physical models and use the analytic results to identify models that will interface properly or improperly.

In some embodiments of the present disclosure, neural networks may be used to recognize new sources of knowledge. Neural networks may be trained to recognize patterns in input data by a repeated process of propagating training data through the network, identifying output errors, and altering the network to address the output error. Training data may be propagated through the neural network, which recognizes patterns in the training data. Those patterns may be compared to patterns identified in the training data by the human annotators in order to assess the accuracy of the neural network. In some embodiments, mismatches between the patterns identified by a neural network and the patterns identified by human annotators may trigger a review of the neural network architecture to determine the particular neurons in the network that contribute to the mismatch. Those particular neurons may then be updated (e.g., by updating the weights applied to the function at those neurons) in an attempt to reduce the particular neurons' contributions to the mismatch. In some embodiments, random changes are made to update the neurons. This process may be repeated until the number of neurons contributing to the pattern mismatch is slowly reduced, and eventually, the output of the neural network changes as a result. If that new output matches the expected output based on the review by the human annotators, the neural network is said to have been trained on that data.

In some embodiments, once a neural network has been sufficiently trained on training data sets for a particular subject matter, it may be used to detect patterns in analogous sets of live data (i.e., non-training data that has not been previously reviewed by human annotators, but that are related to the same subject matter as the training data). The neural network's pattern recognition capabilities can then be used for a variety of applications. For example, a neural network that is trained on a particular subject matter may be configured to review live data for that subject matter and predict the probability that a potential future event associated with that subject matter may occur.

In some embodiments, a multilayer perceptron (MLP) is a class of feedforward artificial neural networks. An MLP consists of, at least, three layers of nodes: an input layer, a hidden layer, and an output layer. Except for the input nodes, each node is a neuron that uses a nonlinear activation function. MLP utilizes a supervised learning technique called backpropagation for training. Its multiple layers and non-linear activation distinguish MLP from a linear perceptron. It can distinguish data that is not linearly separable. Also, MLP can be applied to perform regression operations.

However, accurate event prediction may not be possible with traditional neural networks since terms are not listed in ground truth repositories. For example, if a manufacturer of a device has not been previously identified, the neural network may not be able to identify such a manufacturer.

The amount of data that may be necessary for accurate prediction analysis may be sufficiently large for many subject matters that analyzing the data in a reasonable amount of time may be challenging. Further, in many subject matters, large amounts of data may be made available frequently (e.g., daily), and thus data may lose relevance quickly.

In some embodiments, multiple target predictions may be determined by the overall neural network and combined with structured data in order to predict the likelihood of a value at a range of confidence levels. In some embodiments, these neural networks may be any type of neural network. For example, “neural network” may refer to a classifier-type neural network, which may predict the outcome of a variable that has two or more classes (e.g., pass/fail, positive/negative/neutral, or complementary probabilities (e.g., 60% pass, 40% fail)). For example, pass may denote “no maintenance/service needed” and fail may denote “maintenance/service needed.” “Neural network” may also refer to a regression-type neural network, which may have a single output in the form, for example, of a numerical value.

In some embodiments, for example, a neural network in accordance with the present disclosure may be configured to generate a prediction of the probability of a modification improving the interface between a physical object and a 3D physical part. This configuration may comprise organizing the component neural networks to feed into one another and training the component neural networks to process data related to potential modifications regarding eventual interfaces. In embodiments in which the output of one neural network may be used as the input to a second neural network, the transfer of data from the output of one neural network to the input of another may occur automatically, without user intervention.

As discussed in herein, in some embodiments of the present invention, an aggregate predictor neural network may comprise specialized neural networks that are trained to prepare unstructured and structured data for a new knowledge detection neural network. In some embodiments different data types may require different neural networks, or groups of neural networks, to be prepared for detection of terms.

FIG. 3 illustrates one representation of a set of neural networks in a larger aggregate neural network that may prepare input data for a new knowledge detection neural network. Structured data 302 and unstructured data 304 represent the base inputs to the neural network. Structured data 302 and unstructured data 304 are inputs into neural network 306, which may be trained in the terms (e.g., vocabulary) of the subject matter to which the structured data 302 and unstructured data 304 pertains. Neural network 306 may also be trained to recognize patterns in the structured data 302 and unstructured data 304, and identify a word list based on those patterns. For example, in some embodiments neural network 306 may comprise an entity model that identifies a list of entities 308 within the unstructured data 304 that may be relevant to a target prediction. In other embodiments, however, other types of word lists are possible.

The list of entities 308 is input into neural network 310. Neural network 310 may be specialized to process the list of entities 308 and output at least one feature vector 312. In some embodiments, feature vector 312 may be a numerical feature vector. In some embodiments, for example, neural network 310 may analyze the unstructured data and determine the contextual relationship of each entity in the list of entities 308 to the remainder of the structured data. Neural network 310 may then assign numerical values to the corresponding word vectors of those entities such that entities with close contextual relationships are situated in close proximity in a vector space. Thus, in some embodiments, feature vector 312 may contextually describe an entity based on the perceived relationships of the entity to the other words used in structured data 304. In some embodiments, feature vector 312 may actually represent multiple feature vectors (e.g., one vector for each entity in the list of entities 308). In other embodiments, only one vector may be produced.

Unstructured data 304 is also input into neural network 314, which may be a sentiment classifier neural network. Neural network 314 may process the unstructured data to identify words used throughout the unstructured data to which sentimental context may be ascribed. In some embodiments, this processing may involve tokenizing the unstructured data (i.e., dividing the data into small sections, such as words, that may be easily identified and processed).

Neural network 314 may output sentiment score 316. Sentiment score 316 may take the form of a value within a predetermined range of values (e.g., 1.0 to −1.0) that measures the type of sentiment and magnitude of sentiment associated with a word in a word list identified from within structural data 304. For example, sentiment score 316 may be the sentiment in structured data 304 that is associated with an entity in the list of entities 308. In some embodiments, list of entities 308 may cross-referenced with the output of neural network 314 to identify relevant sentiment scores. In some embodiments, neural network 314 may also output an average sentiment score of the entire structured data 304. This average sentiment score may also be utilized in prediction analysis.

Unstructured data 304 is also input to concept mapper 318. Concept mapper 318 may comprise a database of entities and semantic “facts” about those entities. Those semantic “facts” may include a list of higher-level concepts associated with the entities in the database. Concept mapper 318 may ingest unstructured data 304 and map the words found therein to a list of concepts associated with those entities. In some embodiments, this may include tokenizing the unstructured data and detecting words found in the tokens that are also found in the database of entities. The concepts that are associated with those words may then be determined based on the relationships in the database, and output as concept list 320.

In some embodiments, entity list 308 may also be input into 318 with, or instead of, unstructured data 304. In those embodiments, concept mapper 318 may match the entities found in entity list 308 with entities found in the database associated with concept mapper 318. Concept associations may be identified for any entities that are also found within the database. The concepts identified by those associations may then be output to concept list 320.

In some embodiments, concept list 320 may also be input into neural network 314 with unstructured data 304. Neural network 314 may then determine a sentiment score 316 for at least one concept in the list of concepts 320. This sentiment score may reflect the sentiment associated with the at least one concept in the unstructured data 304. In some embodiments a separate sentiment score 316 may be determined for each concept in list of concepts 320. For example, neural network 314 may determine sentiments as to which types of modifications that result in which types of interfaces are more or less desired. This may include determining, for example, that for some types of parts hollowing out an part to balance the interface is desired, while in other instances a greater “heft” is desired such that the modification includes generating a “press-fit” interface at the identified abutment.

The list of concepts 320 is input into neural network 322. In some embodiments, neural network 322 may be a distinct neural network from neural network 310. In other embodiments neural networks 310 and 322 may be the same network. Neural network 322 may be specialized to process the list of concepts 320 and output at least one feature vector 324. In some embodiments, feature vector 324 may be a numerical feature vector. In some embodiments, feature vector 312 may contextually describe a concept based on the perceived relationships of the concept to the other words used in structured data 304. In some embodiments, feature vector 324 may actually represent multiple feature vectors (e.g., one vector for each concept in the list of concepts 320). In other embodiments, only one vector may be produced.

Unstructured data 304 may also be input into neural network 326. In some embodiments, neural network 326 may be a distinct neural network from neural network 310 and neural network 322. In other embodiments neural networks 310, 322, and 326 may all be the same network. Neural network 326 may be specialized in processing the unstructured data an identifying words that, based on their usage or contextual relationships, may be relevant to a target prediction (referred to herein as “keywords”). Neural network 326 may, for example, select keywords based on the frequency of use within the unstructured data 304. Neural network may then vectorize the selected keywords into at least one feature vector 328.

Neural network 326 may also vectorize the words in unstructured data 304, embedding the vectorized words into a vector space. The vector properties may be created such that the vectors of contextually similar words (based on the usage in unstructured data 304) are located are located in closer proximity in that vector space than vectors of contextually dissimilar words. Neural network 326 may then select word vectors based on the proximity of those word vectors to other word vectors. Selecting word vectors that are located near many other word vectors in the vector space increases the likelihood that those word vectors share contextual relationships with many other words in unstructured data 304, and are thus likely to be relevant to a target prediction. The words embedded in these word vectors may represent “keywords” of the unstructured data 304.

The word vectors produced and selected by neural network 326 may be output as at least one feature vector 328. In some embodiments, feature vector 328 may be a numerical feature vector. In some embodiments, feature vector 328 may contextually describe a keyword based on the perceived relationships of the keyword to the other words used in unstructured data 304. In some embodiments, multiple feature vectors 328 may be output by neural network 326. For example, neural network 326 may be specialized to vectorize and output as feature vectors the 500 words that are used the most frequently in unstructured data 304. In other embodiments, neural network 326 may be specialized to output the 500 feature vectors that have the closest distances to at least a threshold amount of other feature vectors in the vector space.

In some embodiments, the keyword or keywords embedded in feature vector 328 or feature vectors 326 may be input into neural network 314 with unstructured data 304. Neural network 314 may then determine a sentiment score 316 for at least one keyword. This sentiment score may reflect the sentiment associated with the at least one keyword in the unstructured data 304. In some embodiments a separate sentiment score 316 may be determined for each identified keyword.

In some embodiments, a neural network may utilize some or all of the outputs of neural networks 310, 314, 322, and 326 to predict the probability of a target event occurring. The neural network may be specialized to process a vector or set of vectors into which a word type (e.g., an entity, a concept, or a keyword) has been embedded. The neural network may also be specialized to process a sentiment score for at least one word in associated with at least one vector. The neural network may output a predicted probability that the target event will occur.

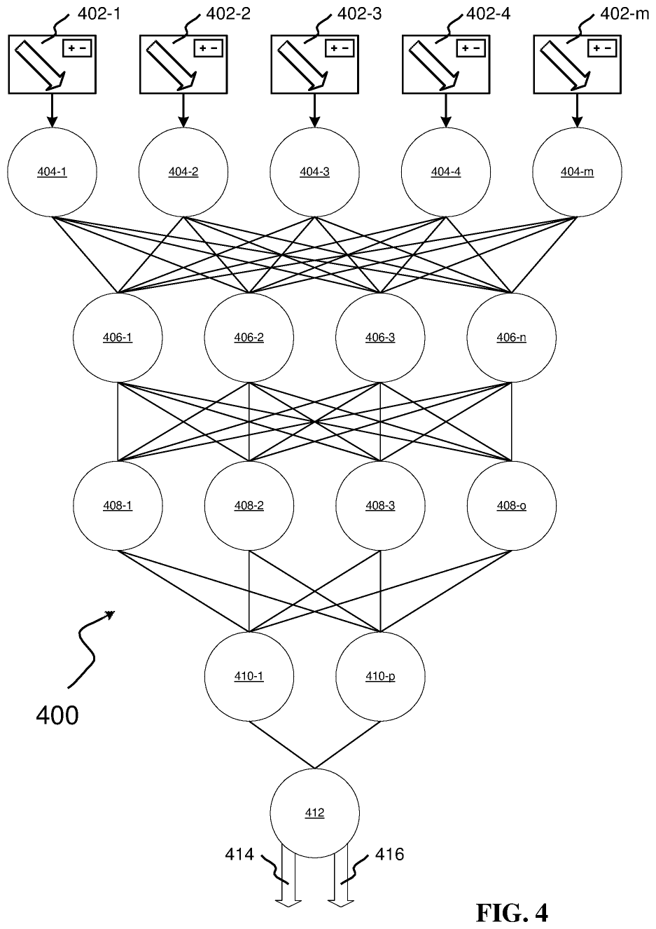

FIG. 4 depicts an example neural network 400 that may be specialized to process a vector or set of vectors associated with a word type (e.g., entity vectors). The neural network 400 may also be specialized to process at least one sentiment score associated with a word embedded within a vector. For example, neural network 400 may be specialized to process one or more outputs of the one or more neural networks disclosed in FIG. 3. In some embodiments, for example, neural network 400 may be specialized to process feature vector 312 (or multiple feature vectors 312) and sentiment score 316 (or multiple sentiment scores 316) of FIG. 3. In other embodiments, neural network 400 may be specialized to process, for example, feature vector 328 (or multiple feature vectors 328) from FIG. 3.

Neural network 400 may be a classifier-type neural network. Neural network 400 may be part of a larger neural network. For example, neural network 400 may be nested within a single, larger neural network, connected to several other neural networks, or connected to several other neural networks as part of an overall aggregate neural network.

Inputs 402-1 through 402-m represent the inputs to neural network 400. In this embodiment, 402-1 through 402-m do not represent different inputs. Rather, 402-1 through 402-m represent the same input that is sent to each first-layer neuron (neurons 404-1 through 404-m) in neural network 400. In some embodiments, the number of inputs 402-1 through 402-m (i.e., the number represented by m) may equal (and thus be determined by) the number of first-layer neurons in the network. In other embodiments, neural network 400 may incorporate 1 or more bias neurons in the first layer, in which case the number of inputs 402-1 through 402-m may equal the number of first-layer neurons in the network minus the number of first-layer bias neurons. In some embodiments, a single input (e.g., input 402-1) may be input into the neural network. In such an embodiment, the first layer of the neural network may comprise a single neuron, which may propagate the input to the second layer of neurons.

Inputs 402-1 through 402-m may comprise a single feature vector that contextually describes a word from a set of unstructured data (e.g., a corpus of natural language sources) and a sentiment score that is associated with the word described by the feature vector. Inputs 402-1 through 402-m may also comprise a plurality of vectors and associated sentiment scores. For example, inputs 402-1 through 402-m may comprise 100 word vectors that describe 100 entities and 100 sentiment scores that measure the sentiment associated with the 100 entities that the 100 word vectors describe. In other embodiments, not all word vectors input into neural network 400 may be associated with a sentiment score. For example, in some embodiments, 30 word vectors may be input into neural network 400, but only 10 sentiment scores (associated with 10 words described by 10 of the 30 word vectors) may be input into neural network 400.

Neural network 400 comprises 5 layers of neurons (referred to as layers 404, 406, 408, 410, and 412, respectively corresponding to illustrated nodes 404-1 to 404-m, nodes 406-1 to 406-n, nodes 408-1 to 408-o, nodes 410-1 to 410-p, and node 412). In some embodiments, neural network 400 may have more than 5 layers or fewer than 5 layers. These 5 layers may each comprise the same amount of neurons as any other layer, more neurons than any other layer, fewer neurons than any other layer, or more neurons than some layers and fewer neurons than other layers. In this embodiment, layer 412 is treated as the output layer. Layer 412 outputs a probability that a target event will occur, and contains only one neuron (neuron 412). In other embodiments, layer 412 may contain more than 1 neuron. In this illustration no bias neurons are shown in neural network 400. However, in some embodiments each layer in neural network 400 may contain one or more bias neurons.

Layers 404-412 may each comprise an activation function. The activation function utilized may be, for example, a rectified linear unit (ReLU) function, a SoftPlus function, a Soft step function, or others. Each layer may use the same activation function, but may also transform the input or output of the layer independently of or dependent upon the ReLU function. For example, layer 404 may be a “dropout” layer, which may process the input of the previous layer (here, the inputs) with some neurons removed from processing. This may help to average the data, and can prevent overspecialization of a neural network to one set of data or several sets of similar data. Dropout layers may also help to prepare the data for “dense” layers. Layer 406, for example, may be a dense layer. In this example, the dense layer may process and reduce the dimensions of the feature vector (i.e., the vector portion of inputs 402-1 through 402-m) to eliminate data that is not contributing to the prediction. As a further example, layer 408 may be a “batch normalization” layer. Batch normalization may be used to normalize the outputs of the batch-normalization layer to accelerate learning in the neural network. Layer 410 may be any of a dropout, hidden, or batch-normalization layer. Note that these layers are examples. In other embodiments, any of layers 404 through 410 may be any of dropout, hidden, or batch-normalization layers. This is also true in embodiments with more layers than are illustrated here, or fewer layers.

Layer 412 is the output layer. In this embodiment, neuron 412 produces outputs 414 and 416. Outputs 414 and 416 represent complementary probabilities that a target event will or will not occur. For example, output 414 may represent the probability that a target device is in a network, and output 416 may represent the probability that a target device is not in the network. In some embodiments, outputs 414 and 416 may each be between 0.0 and 1.0, and may add up to 1.0. In such embodiments, a probability of 1.0 may represent a projected absolute certainty (e.g., if output 414 were 1.0, the projected chance that the target device is in the network occur would be 100%, whereas if output 416 were 1.0, the projected chance that the target device is not in the network would be 100%).

FIG. 4 illustrates an example new knowledge detection neural network with one pattern-recognizer pathway (i.e., a pathway of neurons that processes one set of inputs and analyzes those inputs based on recognized patterns, and produces one set of outputs). However, some embodiments may incorporate a new knowledge detection neural network that may comprise multiple pattern-recognizer pathways and multiple sets of inputs. In some of these embodiments, the multiple pattern-recognizer pathways may be separate throughout the first several layers of neurons, but may merge with another pattern-recognizer pathway after several layers. In such embodiments, the multiple inputs may merge as well (e.g., several smaller vectors may merge to create one vector). This merger may increase the ability to identify correlations in the patterns identified among different inputs, as well as eliminate data that does not appear to be relevant.

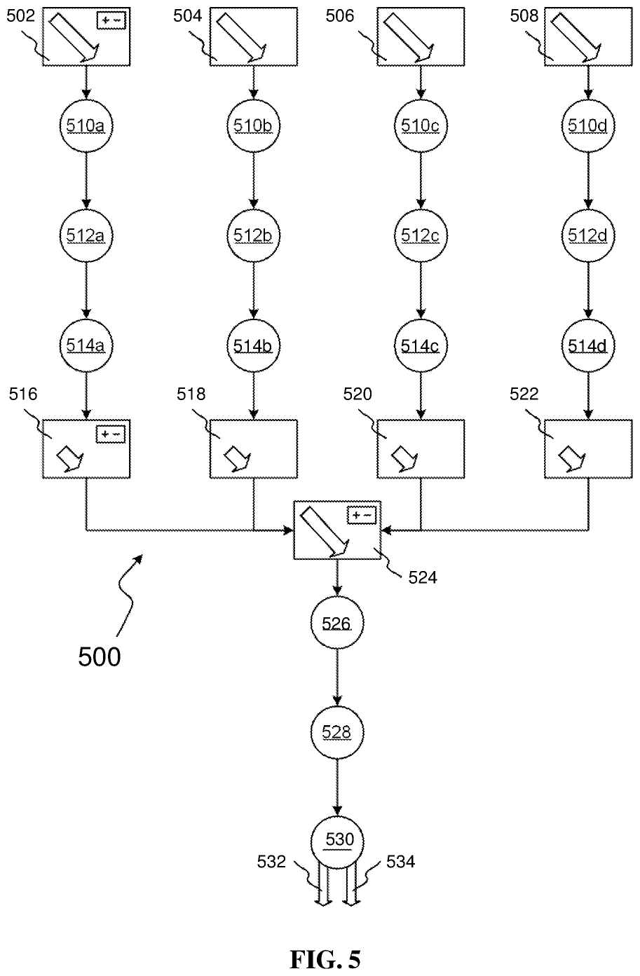

FIG. 5 illustrates an example new knowledge detection neural network 500 with multiple pattern recognition pathways and multiple sets of inputs. For example, inputs 502, combined with layers 510a-514a may represent the first several layers of a pattern-recognizer pathway similar to pattern-recognizer pathway 400 of FIG. 4. For example, input 502 may comprise an entity feature vector or multiple entity vectors and at least one sentiment score for at least one corresponding entity. Input 504 may comprise one or more concept feature vectors and input 506 may comprise one or more keyword feature vectors. Input 508 may be, for example, a sentiment feature vector. The sentiment feature vector may, for example, be composed of sentiment scores for a plurality of entities, keywords, and concepts across a corpus of natural-language sources, embedded into a vector form. For example, a sentiment vector may provide sentiment context for each entity in a group of entities. A sentiment vector may also provide an average sentiment context over a group of keywords. In some embodiments, each feature vector in inputs 502 through 508 may be the same length (e.g., 50 dimensions). In other embodiments each feature vector may have a unique length.

Neural network 500 contains, through the first several layers, four pathways. Several pathway layers (i.e., group of neurons that make up the layer in the pathway) are presented for each pathway. For example, the pathway corresponding to input 502 has three layers shown: 510a, 512a, and 514a. Layer 510a may consist of, for example, 5 neurons that are unique to layer 510a. Layers 510b, 510c, and 510d, of the pathways corresponding to inputs 504, 506, and 508 respectively, may contain 5 corresponding neurons. In other words, the 510 layer of each pathway may contain the same neurons with the same activation function. However, weights distributed among those neurons may differ among the pathways, as may the presence and properties of bias neurons. This may also be true of the 512 layer and 514 layer of each pathway. Each of layers 510a-510d, 512a-512d, and 514a-514d may be a dropout layer, a hidden layer, and a batch-normalization layer. In some embodiments each pathway may have several more layers than are illustrated. For example, in some embodiments each pathway may consist of 8 layers. In other embodiments, the non-input and non-output layers may be in multiples of three. In these embodiments, there may be an equal number of dropout, hidden, and batch normalization layers between the input and output layers.

The outputs of layers 514a-514d are outputs 516-522 respectively. Outputs 516-522 represent the inputs 502-508, however the respective feature vectors have been shortened (i.e., the dimensions of the vectors have been reduced). This reduction may occur, in each pathway, at the hidden layers. The reduction in vector dimensions may vary based on implementation. For example, in some embodiments the vectors in outputs 516-522 may be approximately 50% the length of the vectors in inputs 502-508. In other embodiments, the outputs may be approximately 35% of the length of the inputs. In some embodiments, the length of the output vectors may be determined by the number of hidden layers in the associated pathways and the extent of the vector-length reduction at each hidden layer.

Outputs 516-522 are be combined into a single input/output 524, which may comprise a single vector representing the vectors from outputs 516-522 and the sentiment score obtained from output 516. At this point, all four pathways in the network merge to a single pattern-recognition pathway. This merger may increase the ability to correlate evidence found in each pathway up to this point (e.g., to determine whether patterns being recognized in one pathway are also being recognized in others). This correlation, in turn, may enable the elimination of false-positive patterns and increase the network's ability to identify additional patterns among the merged data. Layer 526 of that pathway may comprise any number of neurons, which may provide inputs for the neurons of layer 528. These layers may provide inputs for the neurons at layer 530, which is the output layer for the network. In some embodiments, layer 530 may consist of a single output neuron. Layer 530 generates two probabilities, represented by output 532 and output 534. Output 532 may be the predicted probability that a target is in the network, and output 534 may be the predicted probability that a target device is not in the network. In this illustration two layers are presented between input/output 524 and output layer 530. However, in some illustrations more or fewer layers may be present after the pathway merge.

Some embodiments of the present disclosure may obtain a composite projection associated with a subject matter based on several neural-network projections for target events associated with the subject matter and other projections available within structured data. In such embodiments, the probabilities of several related or unrelated potential future events may be projected and combined with structured data. A processor configured to perform large-scale multiple regression analysis may combine the projected probabilities with structure data to determine a composite projection.

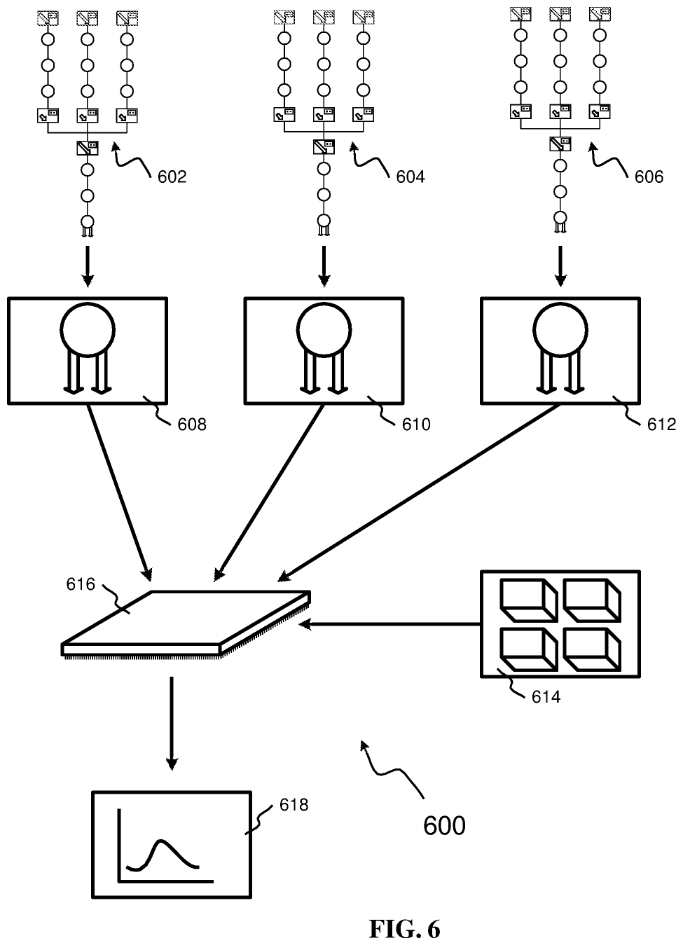

FIG. 6 illustrates a representation of a system 600 that utilizes multiple probability-generation neural networks and structured data to generate a composite projection of 3D printed models. For example, system 600 may be beneficial for identifying patterns in data signaling new knowledge. System 600 utilizes neural networks 602, 604, and 606. Neural networks 602, 604, and 606 may be similar to neural network 500, each comprising multiple pathways similar to neural network 400, and utilizing inputs similar to feature vectors 312, 324, and 328 as well as sentiment score(s) 316. At least one of neural networks 602, 604, and 606 may also utilize a sentiment feature vector similar to the sentiment feature vector of input 508.

Feature vectors may be input into the second pathways of neural networks 602, 604, and 606. The sentiment scores associated with the concepts in the list of concepts may also be determined and input into the second pathways of neural networks 602, 604, and 606 with the concept feature vectors. Relevant keywords may be selected by a neural network based on identified contextual relationships and embedded into keyword feature vectors. A sentiment score may also be determined for each identified keyword. Together, keyword feature vectors and associated sentiment scores may be inputted into the third pattern recognizer pathway in each of neural networks 602, 604, and 606.

In some embodiments, neural networks 602, 604, and 606 may be specialized in predicting the probabilities (e.g., expected values) of different target events. In these embodiments, the lists of entities, keywords, and concepts, that may be relevant to each of neural networks 602, 604, and 606 may differ. For that reason, each of neural networks 602, 604, and 606 may accept different groups of feature vectors.

In some embodiments one or more of neural networks 602, 604, and 606 may specialize in processing at least a fourth vector type. For example, each of neural networks 602, 604, and 606 may comprise a fourth pathway that is specialized in processing a sentiment feature vector.

Neural networks 602, 604, and 606 may output probabilities 608, 610, and 612 respectively. Probabilities 608, 610, and 612 may be any projection of a particular device string or pattern in the data indicates new knowledge. For example, probability 608 may be an indication of a new operating system. Probability 610 may be the probability new manufacturer created a device. Probability 612 may be the probability that a new device is present.

In this illustration of system 600, only three new knowledge detection neural networks have been depicted. However, in some embodiments of system 600 further new knowledge detection neural networks may be utilized. For example, a fourth new knowledge detection neural network may be utilized to determine the projected probability that a new device is connected to a network. In other embodiments fewer than three new knowledge detection neural networks may be utilized, such as embodiments that only project a probability that a device is using a new operating system.

Probabilities 608, 610, and 612 are input, with structured data 614, into processor 616, which is configured to perform a multiple-regression analysis. This multiple-regression analysis may be utilized to develop an overall projection 618, which may be calculated in terms of confidence intervals. For example, processor 616 may be utilized to project knew knowledge in a data set on the projected probabilities 608, 610, and 612 associated with that any similar projections that may be identified in structured data 614. This new knowledge score may be presented in confidence intervals based on the output of the multiple-regression analysis.

While system 600 was discussed in reference to a composite projection associated with rapid prototyping, system 600 may be used to generate a composite prediction in many other subject matters.

As used herein, the term “neural network” may refer to an aggregate neural network that comprises multiple sub neural networks, or a sub neural network that is part of a larger neural network. Where multiple neural networks are discussed as somehow dependent upon one another (e.g., where one neural network's outputs provides the inputs for another neural network), those neural networks may be part of a larger, aggregate neural network, or they may be part of separate neural networks that are configured to communicate with one another (e.g., over a local network or over the internet).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system comprising:
a memory; and
a processor in communication with the memory, the processor being configured to perform processes comprising:
receiving a three-dimensional (3D) model;
receiving information on a physical object;
identifying an abutment between the 3D model and the physical object from the information;
identifying one or more constraints on the 3D model using the information;
modifying the 3D model to interface with the physical object at the abutment and subject to the constraints; and
manufacturing the 3D model into a 3D physical part.

2. The system of claim 1, wherein the information includes physical characteristics for the 3D physical part.

3. The system of claim 1, wherein the process further includes:
receiving user input on how the 3D physical part will contact the physical object at the abutment.

4. The system of claim 3, wherein the process further comprises:
selecting a material and a method of manufacture for the 3D physical part based on the user input and the information on the physical object.

5. The system of claim 4, wherein the process further comprises:
modifying the 3D model for printing properties of the 3D physical part; and
creating a printing file for the 3D physical part.

6. The system of claim 1, wherein the information is selected form a group consisting of a dimension of the physical object, a weight of the physical object, and a center of gravity of the physical object.

7. The system of claim 1, wherein the process further includes:
verifying the physical properties of the 3D physical part.

8. A method comprising:
receiving a three-dimensional (3D) model;
receiving information on a physical object;
identifying an abutment between the 3D model and the physical object from the information;
identifying one or more constraints on the 3D model using the information;
modifying the 3D model to interface with the physical object at the abutment and subject to the constraints; and
manufacturing the 3D model into a 3D physical part.

9. The method of claim 8, wherein the information includes physical characteristics for the 3D physical part.

10. The method of claim 8, wherein the process further includes:
receiving user input on how the 3D physical part will contact the physical object at the abutment.

11. The method of claim 10, wherein the process further comprises:
selecting a material and a method of manufacture for the 3D physical part based on the user input and the information on the physical object.

12. The method of claim 11, wherein the process further comprises:
modifying the 3D model for printing properties of the 3D physical part; and
creating a printing file for the 3D physical part.

13. The method of claim 8, wherein the information is selected form a group consisting of a dimension of the physical object, a weight of the physical object, and a center of gravity of the physical object.

14. The method of claim 8, wherein the process further includes:
verifying the physical properties of the 3D physical part.

15. A computer program product comprising a computer readable storage medium having program instructions embodied therewith, the program instructions executable by a processor to cause the processors to perform a method, the method comprising:
receiving a three-dimensional (3D) model;
receiving information on a physical object;
identifying an abutment between the 3D model and the physical object from the information;
identifying one or more constraints on the 3D model using the information;
modifying the 3D model to interface with the physical object at the abutment and subject to the constraints; and
manufacturing the 3D model into a 3D physical part.

16. The computer program product of claim 15, wherein the information includes physical characteristics for the 3D physical part.

17. The computer program product of claim 15, wherein the process further includes:
receiving user input on how the 3D physical part will contact the physical object at the abutment.

18. The computer program product of claim 17, wherein the process further comprises:
selecting a material and a method of manufacture for the 3D physical part based on the user input and the information on the physical object.

19. The computer program product of claim 18, wherein the process further comprises:
modifying the 3D model for printing properties of the 3D physical part; and
creating a printing file for the 3D physical part.

20. The computer program product of claim 15, wherein the information is selected form a group consisting of a dimension of the physical object, a weight of the physical object, and a center of gravity of the physical object.
